(19) United States
(12) Patent Application Publication
(10) Pub. No.: US 2024/0222949 A1
(43) Pub. Date: Jul. 4, 2024

(54) MODULAR ELECTRICAL WIRING DEVICE PLATFORM AND ASSEMBLIES

(71) Applicant: Pass & Seymour, Inc., Syracuse, NY (US)

(72) Inventor: Richard M. Rohmer, Memphis, NY (US)

(73) Assignee: Pass & Seymour, Inc., Syracuse, NY (US)

(21) Appl. No.: 18/397,070

(22) Filed: Dec. 27, 2023

Related U.S. Application Data
(60) Provisional application No. 63/477,453, filed on Dec. 28, 2022.

(51) Int. Cl. H02G 3/10; H01R 13/04; H01R 13/11; H01R 13/713; H01R 13/74; H01R 25/00; H02G 3/14; H02G 3/18

(52) U.S. Cl. CPC H02G 3/10; H01R 13/04; H01R 13/113; H01R 13/7135; H01R 13/743; H01R 25/006; H02G 3/14; H02G 3/18; H01R 2103/00

(57) ABSTRACT

A powered subplate device, the device including a front face and a rear face. The front face includes a recessed portion extending from the front face toward the back face, where the recessed portion is configured to receive an electrical wiring device, and the recessed portion includes one or more receptacle terminals. The one or more receptacle terminals extend perpendicular to the front face, where a rear facing end of the one or more receptacle terminals are configured to connect to AC wires on the rear face of the powered subplate. The front facing end of the one or more receptacle terminals are configured to mate with plug blades of the electrical wiring device.

### PRIORITY

This application claims priority to U.S. Provisional Patent Application No. 63/477,453, filed on Dec. 28, 2022, entitled MODULAR ELECTRICAL WIRING DEVICE PLATFORM AND ASSEMBLIES, the contents of which are incorporated by reference in their entireties.

### FIELD OF THE INVENTION

The present invention relates generally to electrical wiring devices, and particularly to electrical wiring device assemblies/platforms and components thereof where an electrical wiring device can easily be installed in and swapped out of a device wall box in a hot condition.

### BACKGROUND

Electrical power is provided to users by way of electrical distribution systems that typically include electrical wiring from a utility power source to a breaker panel disposed in a house, building or some other facility. The breaker panel distributes AC power to one or more branch electric circuits installed in the structure. The electric circuits may typically include one or more electrical wiring devices that regulate, monitor or provide AC power to other devices (loads). There are a variety of electrical wiring devices available to the consumer including outlet receptacles, light switches, dimmers, ground fault circuit interrupters, arc fault circuit interrupters and the like.

Each electrical wiring device is equipped with electrical terminals that provide a means for connecting the device to the source of AC power and a means for connecting the device to a load. Specifically, line terminals couple the device to the source of AC electrical power, whereas load terminals couple power to the load. Load terminals may also be referred to as “feed-through” or “downstream” terminals because the wires connected to these terminals may be coupled to a daisy-chained configuration of receptacles or switches.

Thus, an electric circuit may include many different electrical wiring devices disposed at various locations throughout a structure. Outlet receptacles, switches and protective devices are examples of types of electrical wiring devices. Ground fault circuit interrupters (GFCIs) and arc fault circuit interrupters (AFCIs) are examples of protective devices in electric circuits. One or more electrical wiring devices may be mounted to a device box depending on the size of the device box. A single-gang device box typically accommodates one electrical wiring device; a two-gang device box will typically accommodate two electrical wiring devices, etc. An electrical wiring device provides the consumer with a point of access to electrical service. For example, a receptacle outlet provides power to a portable device when the device's corded power plug is inserted into an energized receptacle. Once an electrical wiring device is installed inside the device box, a cover plate can be disposed over the electrical wiring device to “complete the electrical enclosure” such that individuals are not exposed to “hot” electrical wiring after the electrical power is turned on.

Description of the Related Art Section Disclaimer: To the extent that specific patents/publications/products are discussed above in this Background Section or elsewhere in this Application, these discussions should not be taken as an admission that the discussed patents/publications/products are prior art for patent law purposes. For example, some or all of the discussed patents/publications/products may not be sufficiently early in time, may not reflect subject matter developed early enough in time and/or may not be sufficiently enabling so as to amount to prior art for patent law purposes. To the extent that specific patents/publications/products (and/or specific portions thereof) are discussed above in this Background Section and/or throughout the application, the descriptions/disclosures of which are all hereby incorporated by reference into this document in their respective entirety(ies) (or at least the specific references sections are incorporated by reference into this document in their respective entirety(ies), as may be applicable).

### SUMMARY

There are several drawbacks associated with conventional or standard devices/platforms/assemblies and/or the installation methods related to the same. As illustrated in FIG. 1, a standard electrical wiring device (e.g., a switch) is shown being installed into a device box, and the wires being directly connected to the electrical wiring device. Mounting electrical wiring devices to the device box in a conventional manner is tedious, time consuming, and therefore costly. The inventors recognize that what is needed is a quicker, easier and safer way to install electrical wiring devices to and within a device wall box.

The present invention addresses the needs described above by providing a powered subplate that can be connected to AC power wires on the rear surface of the same (as should be understood by a person of ordinary skill in the art in conjunction with a review of this disclosure) and attached to a device box. The powered subplate can include contacts that can mate with contacts of an electrical wiring device (hot, neutral and/or load, as should be understood by a person of ordinary skill in the art in conjunction with this disclosure) to provide power to the electrical wiring device, while also providing protection to the user from electrical shocks (see receptacle terminals or openings or slits which are sized to allow insertion of plug blades of an electrical wiring device in the accompanying figures, and to prevent fingers from touching the electrical contacts position therewithin (similar to outlet receptacle terminals)). An electrical wiring device can be positioned within an opening formed by the subplate (which can be similar in shape to the device box). In summary, a subplate of an embodiment facilitates a safer installation of an electrical wiring device.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description are merely exemplary of the invention, and are intended to provide an overview or framework for understanding the nature and character of the invention as it is claimed. It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

The accompanying drawings are included to provide a further understanding of the invention, and are incorporated in and constitute a part of this specification. The drawings illustrate various embodiments of the invention and together with the description serve to explain the principles and operation of the invention.

### BRIEF DESCRIPTION OF THE DRAWINGS

The present invention will be more fully understood and appreciated by reading the following Detailed Description in conjunction with the accompanying drawings, in which:

FIG. 1 is a front perspective exploded view of a standard powered subplate and electrical wiring device system;

FIG. 2A is a front perspective exploded view of a wall box and powered subplate system, according to an embodiment;

FIG. 2B is a rear perspective view of a powered subplate, according to an embodiment;

FIG. 2C is a rear perspective view of a powered subplate, according to an embodiment;

FIG. 3 is a rear perspective view of an electrical wiring device configured to connect to the powered subplate system of FIG. 1 according to an embodiment;

FIG. 4 is a front perspective view of the powered subplate of FIG. 1, according to an embodiment;

FIG. 5A is a front perspective view of the fully combined wall box and powered subplate system, showing a step in the installation of an electrical wiring device into to powered subplate system according to an embodiment;

FIG. 5B is a front perspective view of the fully combined wall box and powered subplate system, showing another step in the installation of an electrical wiring device into to powered subplate system according to an embodiment;

FIG. 5C is a front perspective view of the fully combined wall box and powered subplate system, showing another step in the installation of an electrical wiring device into to powered subplate system according to an embodiment;

FIG. 5D is a front perspective view of the fully combined wall box and powered subplate system, showing another step in the installation of an electrical wiring device into to powered subplate system according to an embodiment;

FIG. 6A is a front perspective view of an example representative electrical wiring device configured to connect to the powered subplate system, according to an embodiment;

FIG. 6B is a front perspective view of another example representative electrical wiring device configured to connect to the powered subplate system, according to an embodiment;

FIG. 6C is a front perspective view of another example representative electrical wiring device configured to connect to the powered subplate system, according to an embodiment;

FIG. 6D is a front perspective view of another example representative electrical wiring device configured to connect to the powered subplate system, according to an embodiment;

FIG. 7A is a front perspective exploded view of a powered subplate and electrical wiring device system configured to connect to an external subplate, according to an embodiment;

FIG. 7B is a front perspective exploded view of a powered subplate and electrical wiring device system configured to connect to a faceplate, according to an embodiment; and

FIG. 7C is a front perspective view of a sellable powered subplate electrical wiring device and faceplate system, according to an embodiment.

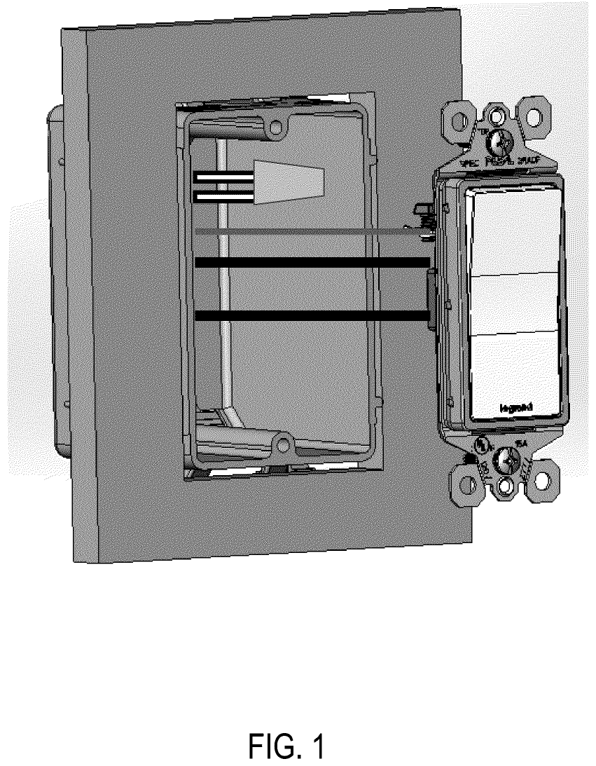

### DETAILED DESCRIPTION

Aspects of the present invention and certain features, advantages, and details thereof, are explained more fully below with reference to the non-limiting examples illustrated in the accompanying drawings. Descriptions of well-known structures are omitted so as not to unnecessarily obscure the invention in detail. It should be understood, however, that the detailed description and the specific non-limiting examples, while indicating aspects of the invention, are given by way of illustration only, and are not by way of limitation. Various substitutions, modifications, additions, and/or arrangements, within the spirit and/or scope of the underlying inventive concepts will be apparent to those skilled in the art from this disclosure.

While embodiments of the present invention have been particularly shown and described with reference to certain exemplary embodiments, it will be understood by one skilled in the art that various changes in detail may be effected therein without departing from the spirit and scope of the invention as defined by claims that can be supported by the written description and drawings. Further, where exemplary embodiments are described with reference to a certain number of elements it will be understood that the exemplary embodiments can be practiced utilizing either less than or more than the certain number of elements. If elements are shown in a particular Figure discussed below are not specifically identified with respect to that Figure, the elements should be sufficiently identified with respect to at least one other Figure.

Conventional subplate systems generally comprise a powered subplate coupled to AC power on the rear side and an electrical wiring device (EWD) on the front side. Load terminals on both devices may be exposed to the user, resulting in the potential for electric shock. The present invention provides for a device that reduces the potential for electric shock and allows for quicker installation.

Various embodiments include a powered subplate having a rear surface and a front surface. The subplate can be connected to AC power wires on the rear surface allowing connection to the circuit in a standard wall box. The front surface of the subplate may include subplate contacts or receptacle terminals capable of mating with contacts of an EWD. The receptacle terminals of the powered subplate may be recessed into the subplate. The receptacle terminals include electrical contacts that can mate with contacts on an EWD providing access to the circuit.

The powered subplate may include a recessed opening capable of receiving an EWD. The opening may be rectangular, circular, elliptical, or other shapes capable of receiving an EWD.

In some embodiments, the device may include an electrical wiring device (EWD). The EWD may include a rear face and front face. The rear face of the EWD may include one or more plug blades capable of mating with the receptacle terminals of the powered subplate. The rear face of the EWD may be configured to complement the shape of the front surface of the powered subplate or the recessed opening. By complementing the shape of the front surface of the powered subplate and mating the plug blades with the receptacle terminals of the powered subplate, the device prevents electrical shocks as a user's fingers are less likely to come in contact with the electrical contacts.

The EWD may be a variety of devices in various embodiments including a standard deco switch, a smart switch, a standard dimmer, a smart dimmer, a standard receptacle, a smart receptacle, a USB receptacle, a TVSS, an occupancy sensor, and a night light. Mating the plug blades of an EWD with receptacles of a powered subplate allows for easy removal and changeability of EWDs without risk of electrical shock. Various embodiments of the present invention reduce the need to rewire EWDs after initial installation of the powered subplate.

Turning now to the figures, the figures represent exemplary embodiments of the invention, examples of which are illustrated in the accompanying drawings. Wherever possible, the same reference numbers will be used throughout the drawings to refer to the same or like parts.

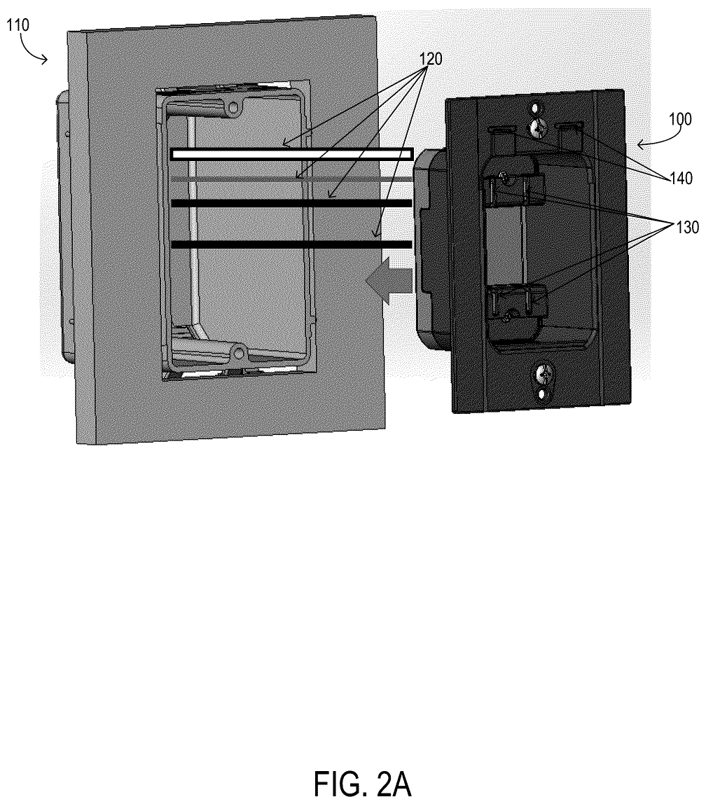

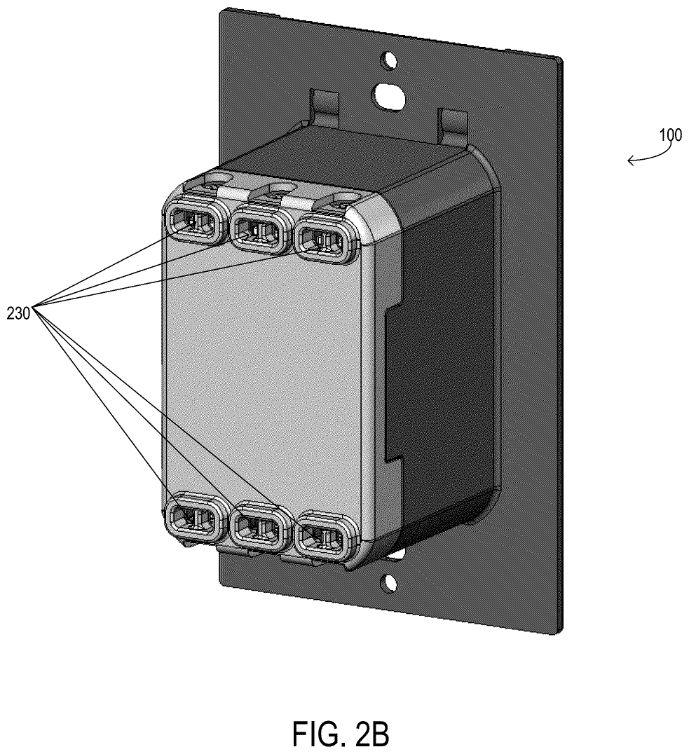

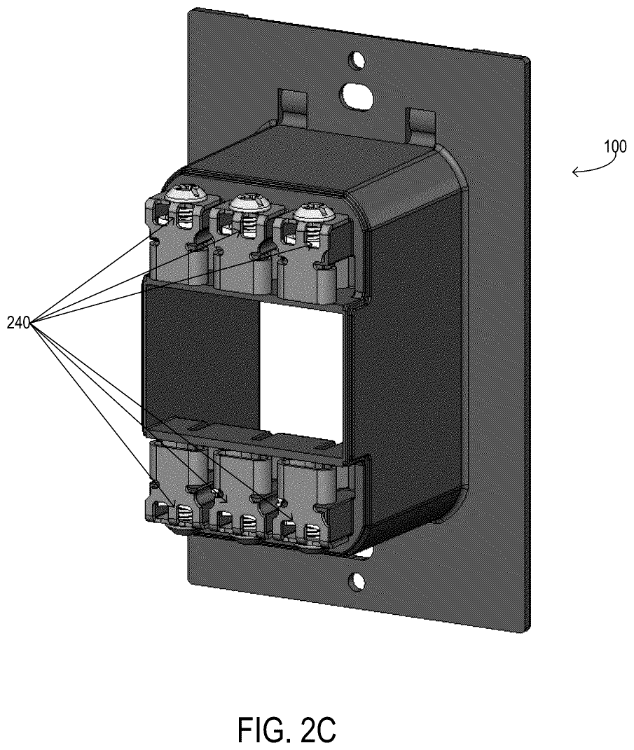

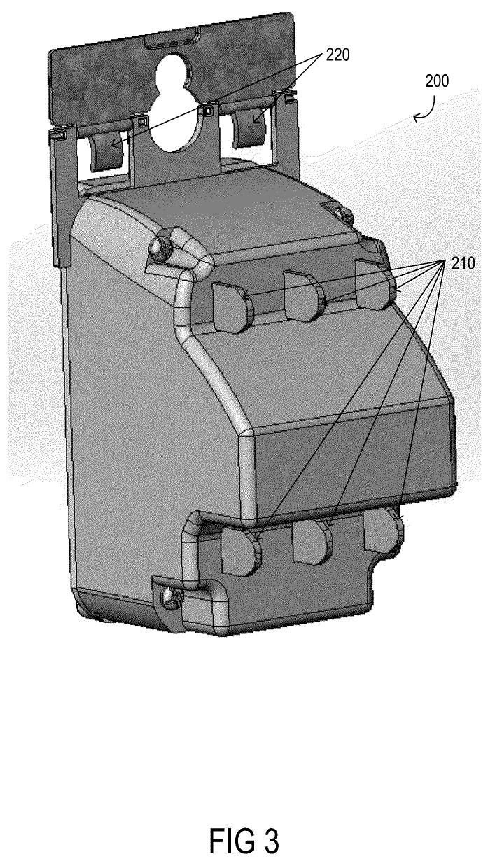

FIG. 2A depicts a powered subplate 100 as it connects to a wall box 110. AC wires 120 connect the powered subplate 100 to the wall box 110. Receptacle terminals 130 may be recessed into the powered subplate 100. The rear face of the powered subplate 100 is shaped to complement the recess of the wall box 110. The receptacle terminals 130 are configured to mate with an electrical wiring device's 200 plug blades 210 as shown in FIG. 3. The powered subplate 100 may be configured to fit and be positioned within/sit within a standard wall box 110 and capable of mating with a number of different EWDs 200 (as should be understood by a person of ordinary skill in the art in conjunction with a review of this disclosure). In some embodiments, the powered subplate 100 may shaped and sized to receive two or more EWDs 200. For example, in an embodiment, there may be one gang, two gangs, or even more suitable arrangements of EWDs 200. The powered subplates 100 may be manufactured to include different gang arrangements for different uses and products.

In another example, the powered subplate 100 may have multiple gangs next to one another in a multiple single gang powered subplate 100. This and other examples may include flanges on the sides that may be broken off by a user or installer.

FIG. 2B depicts a rear perspective view of a powered subplate 100. The rear of the powered subplate 100 may include a rear protrusion from the face of the subplate 100 configured to mate with a wall box 110. The rear face of the powered subplate 100 may also include one or more ports 230 capable of connecting to one or more AC wires 120. The ports 230 may connect the circuit through the AC wires 120 to the receptacle terminals 130 on the front face of the powered subplate 100.

FIG. 2C depicts a rear perspective of a powered subplate 100. The rear of the powered subplate 100 may include a rear protrusion configured to mate with a wall box 110. The rear face of the powered subplate 100 may also include one or more screw connection terminals 240 configured to connect to AC wires 120.

FIG. 3 depicts a rear facing view of an electrical wiring device (EWD) 200. The EWD 200 can include one or more plug blades 210 on the rear face capable of mating with the receptacle terminals 130 of the powered subplate 100, as shown in FIG. 3. The rear face of the EWD 200 complements the recess of the front face of the powered subplate 100. The EWD may comprise one or more clips 220 capable of snapping on to one or more clip receptacles 140 of the powered subplate. The clips 220 allow for easy assembly and removal of the EWD 200 from the powered subplate 100.

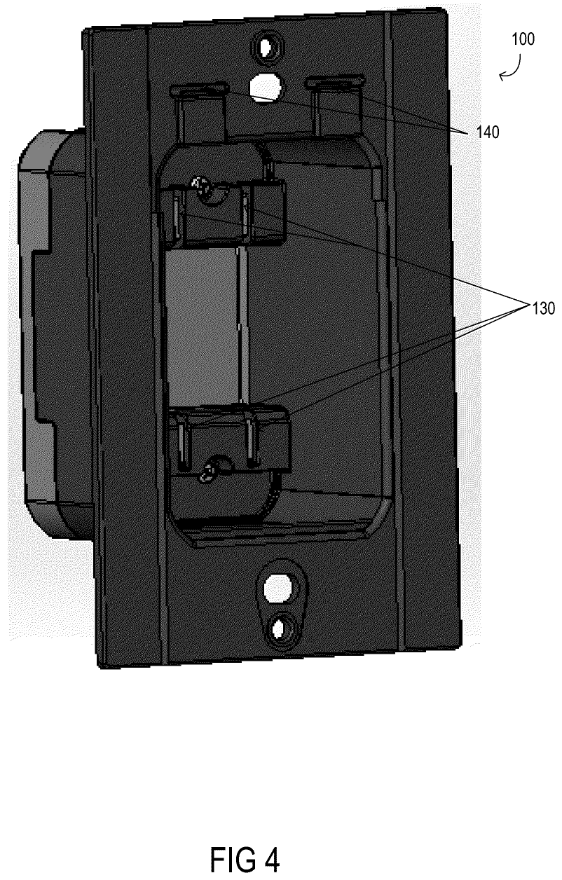

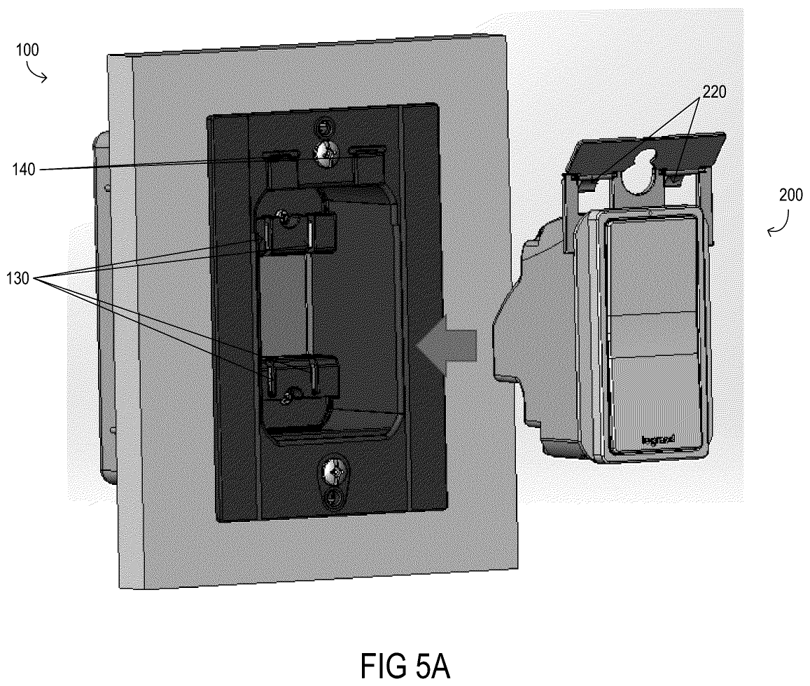

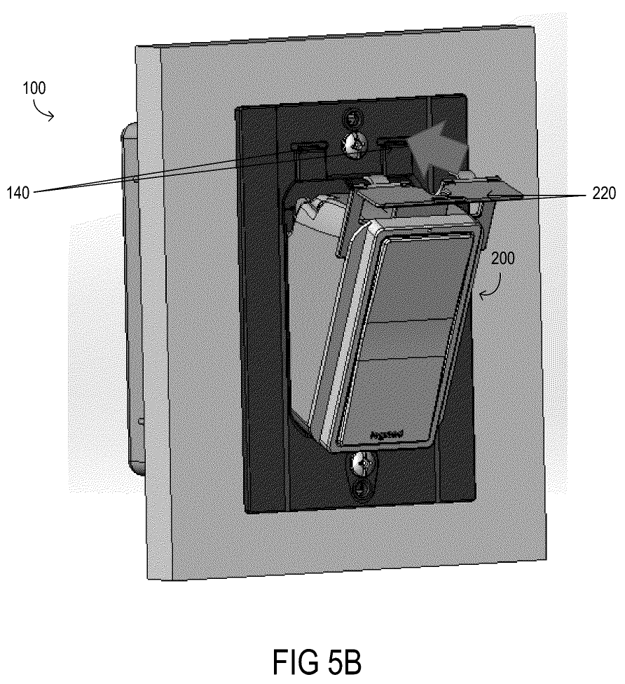

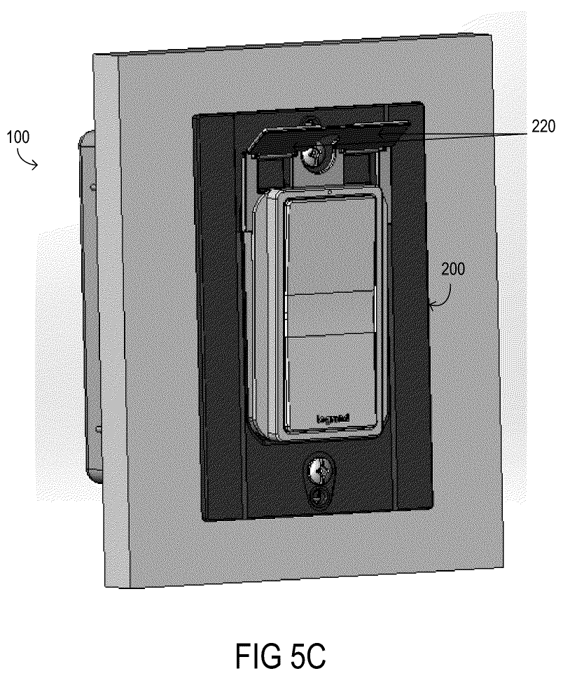

FIG. 4 depicts a front facing view of an embodiment of a powered subplate 100. The subplate 100 may include a recess in the front face of the subplate 100. The recess may be shaped/sized to complement the shape/size of the rear face of an EWD 200. The powered subplate 100 may include within the recess one or more receptacle terminals 130 capable of mating with plug blades 210 of an EWD 200. The receptacle terminals 130 may be shaped/sized to complement the shape of plug blades 210 of an EWD 200. These receptacle terminals 130 are positioned within receptacle openings created by interior/recess portion(s)/surface(s) of the powered subplate 100 that extend above and preferably fully surround (i.e., so that the electrical contacts positioned therein do not extend thereabove, and cannot be touched by a user). Mating the receptacle terminals 140 with the plug blades 210 allows for safe and easy replacement of an EWD 200 in the system (as shown and described with respect to FIGS. 5A-5D). Portions of the powered subplate 100 surrounding the receptacle terminals may be made of a non-conductive material, such as a thermoplastic, reducing the risk of electrical shock to a user.

The powered subplate 100 may also include clip receptacles 140 configured to receive clips 220 from the EWD 200 in order to secure the EWD 200 to the powered subplate. The clips 220 of the EWD 200 are configured to snap into the clip receptacles 140 during installation, and unsnap from the clip receptacles 140 during removal of the EWD 200.

FIGS. 5A-5D depict installation of an EWD 200 into a powered subplate 100. FIG. 4A depicts the beginning installation of an embodiment of an EWD 200 into a powered subplate 100. The rear face of the EWD 200 is configured to complement the recess of the powered subplate 100. One or more plug blades 210 are aligned with the one or more receptacle terminals 130 in order to mate them. The EWD 200 is advanced toward the powered subplate 100. The one or more clips 220 may be in a lowered position for easier insertion into one or more clip receptacles 140.

FIG. 5B further depicts installation of an EWD 200 into a powered subplate 100. The one or more plug blades 210 (not visible) mate with the one or more receptacle terminals 130 (not visible).

FIG. 5C further depicts installation of an EWD 200 into a powered subplate 100. The EWD 200 may be inserted so its front face sits flush with the front face of the powered subplate 100. The plug blades 210 are fully mated with the receptacle terminals 130.

FIG. 5D depicts a fully installed EWD 200 in a powered subplate 100. One or more clips 220 are raised into a locked position in the one or more clip receptacles to secure the EWD 200 in the powered subplate 100. To remove the EWD 200 from the powered subplate 100 the process is simply reversed. This process allows for a “hot swap” of EWDs 200, or switching EWDs 200 without turning off the power to the circuit, as a user's fingers are less likely to come into contact with the terminals 130 compared with conventional devices/assemblies. In some embodiments, the AC wires 120 are completely hidden from the user, making switching EWDs 200 safer and faster.

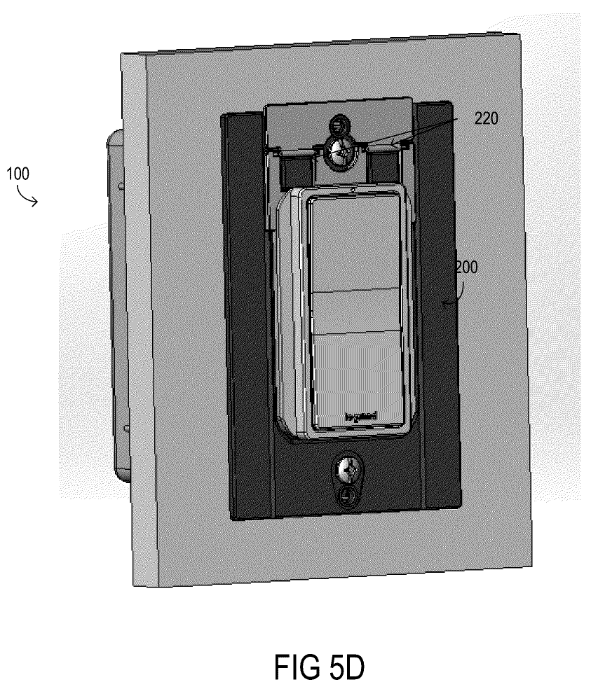

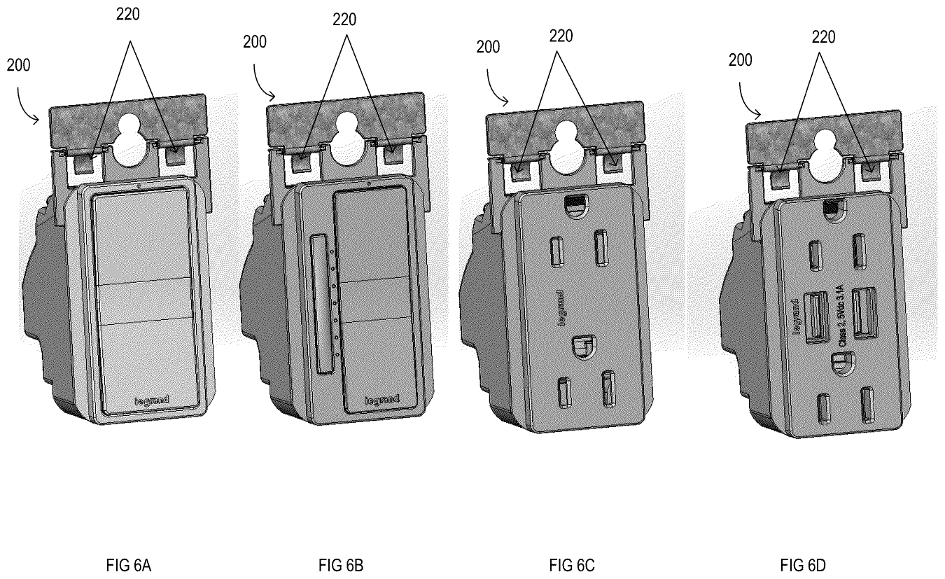

FIGS. 6A-6D depict illustrative embodiments of EWDs 200. FIG. 6A depicts a switch. FIG. 6B depicts a switch with a dimmer. FIG. 6C depicts two US outlets. FIG. 6D depicts two US outlets and two USB outlets. These EWDs 200 may be interchangeable with each other while using the same powered subplate 100.

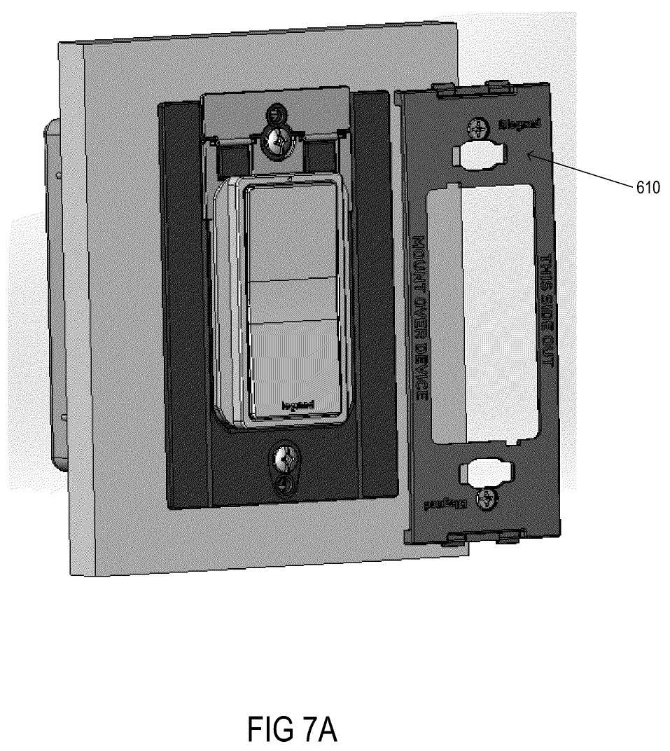

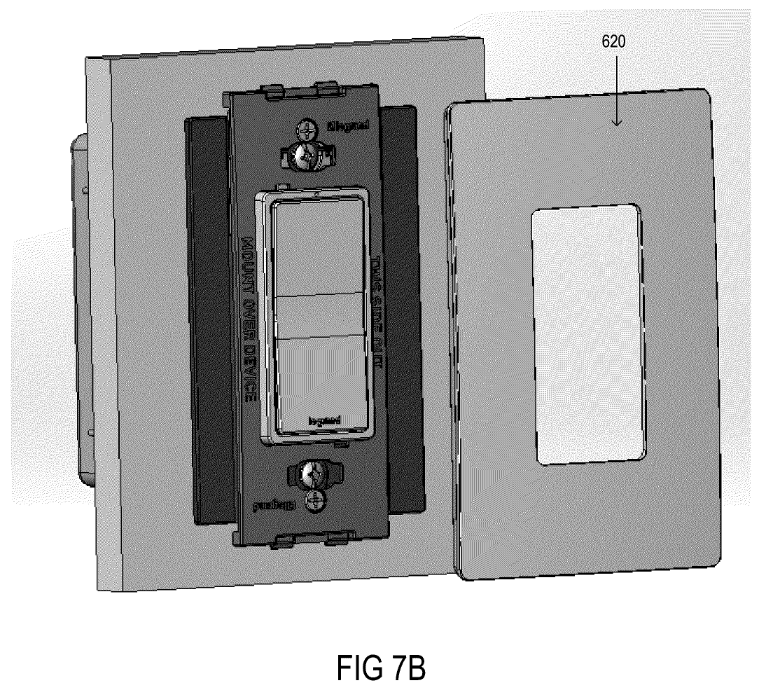

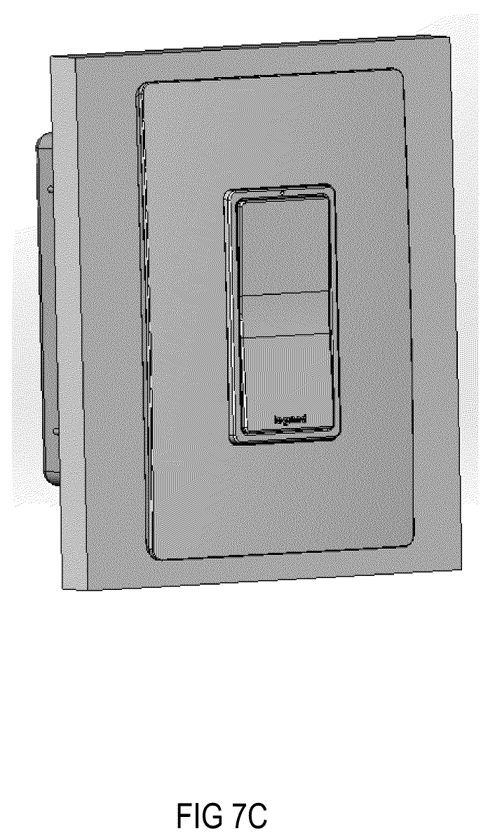

FIGS. 7A-7D depict illustrative embodiments of fully installed EWDs 200 in a powered subplate 100 with finishing faceplates. FIG. 7A depicts installation of an external subplate 610 over the assembled EWD 200 and powered subplate 100. The external subplate 610 is mounted over the device to further secure the EWD 200 on the powered subplate 100.

FIG. 7B depicts a secured external subplate 610 and installation of a faceplate 620. A faceplate 620 further secures the EWD 200 and powered subplate 100 system, and provides an aesthetically pleasing exterior for the system.

FIG. 7C depicts an embodiment of a final, sellable product for installation. This product includes the powered subplate 100, EWD 200, external subplate 610, and faceplate 620. The faceplate 620 may be sold separately from the powered subplate 100 and EWD 200 system. The faceplate 620 may also be a standard faceplate 620 as is known in the industry.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto; inventive embodiments may be practiced otherwise than as specifically described and claimed.

All references, including publications, patent applications, and patents, cited herein are hereby incorporated by reference to the same extent as if each reference were individually and specifically indicated to be incorporated by reference and were set forth in its entirety herein.

All definitions, as defined and used herein, should be understood to control over dictionary definitions, definitions in documents incorporated by reference, and/or ordinary meanings of the defined terms.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

Approximating language, as used herein throughout the specification and claims, may be applied to modify any quantitative representation that could permissibly vary without resulting in a change in the basic function to which it is related. Accordingly, a value modified by a term or terms, such as “about” and “substantially” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

The recitation of ranges of values herein are merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not impose a limitation on the scope of the invention unless otherwise claimed.

No language in the specification should be construed as indicating any non-claimed element as essential to the practice of the invention.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

It will be apparent to those skilled in the art that various modifications and variations can be made to the present invention without departing from the spirit and scope of the invention. There is no intention to limit the invention to the specific form or forms disclosed, but on the contrary, the intention is to cover all modifications, alternative constructions, and equivalents falling within the spirit and scope of the invention, as defined in the appended claims. Thus, it is intended that the present invention cover the modifications and variations of this invention provided they come within the scope of the appended claims and their equivalents.

What is claimed is:

1. A powered subplate device, the device comprising:
a front face and a rear face,
the front face comprising a recessed portion extending from the front face toward the back face,
wherein the recessed portion is configured to receive an electrical wiring device,
wherein the recessed portion comprises one or more receptacle terminals; and
wherein the one or more receptacle terminals extend perpendicular to the front face,
wherein a rear facing end of the one or more receptacle terminals are configured to connect to AC wires on the rear face of the powered subplate, and
wherein a front facing end of the one or more receptacle terminals are configured to mate with plug blades of the electrical wiring device.

2. The powered subplate of claim 1, wherein the rear facing end of the one or more receptacle terminals are ports configured to mate with AC wires.

3. The powered subplate of claim 1, wherein the rear facing end of the one or more receptacle terminals are screw connection terminals configured to connect to AC wires.

4. The powered subplate of claim 1 further comprising:
one or more clip receptacles on the front face configured to mate with one or more clips on the electrical wiring device.

5. The powered subplate of claim 1, wherein the one or more receptacle terminals are positioned within receptacle openings such that the receptacle openings reduce user contact with the receptacle terminals.

6. The powered subplate of claim 5, wherein the one or more receptacle terminals are positioned within receptacle openings created by a surface of the powered subplate that extends above and fully surrounds the one or more receptacle terminals.

7. A system comprising:
a powered subplate, comprising:
a front face and a rear face,
the front face comprising a recessed portion extending from the front face toward the back face,
wherein the recessed portion is configured to receive an electrical wiring device,
wherein the recessed portion comprises one or more receptacle terminals; and
wherein the one or more receptacle terminals extend perpendicular to the front face; and
an electrical wiring device (EWD) comprising:
one or more plug blades on a rear surface of the EWD;
wherein the one or more plug blades are configured to mate with the one or more receptacle terminals.

8. The system of claim 12, wherein the EWD is selected from a group consisting of: a standard deco switch, a smart switch, a standard dimmer, a smart dimmer, a standard receptacle, a smart receptacle, a USB receptacle, a TVSS, an occupancy sensor, and a night light.

16. The system of claim 12, wherein the powered subplate further comprises one or more clip receptacles.

17. The system of claim 12, wherein the EWD further comprises one or more clips.

18. The system of claim 12, wherein the powered subplate is configured to accept two or more EWDs.

19. The system of claim 12, wherein the EWD is a ground fault circuit interrupter.

20. The system of claim 12, wherein the EWD is an arc fault circuit interrupter.
